(19) United States
(12) Patent Application Publication
(10) Pub. No.: US 2012/0262934 A1
(43) Pub. Date: Oct. 18, 2012

(54) TAIL LIGHT ASSEMBLY FOR A MOTOR VEHICLE

(75) Inventors: Jonathan Disley, Kungalv (SE); Andreas Nilsson, Kungalv (SE)

(73) Assignee: VOLVO CAR CORPORATION, Goteborg (SE)

(21) Appl. No.: 13/430,980

(22) Filed: Mar. 27, 2012

(30) Foreign Application Priority Data
Apr. 13, 2011 (EP) 11162253.6

(51) Int. Cl. B60Q 1/30; F21V 25/02; F21V 9/10

(52) U.S. Cl. 362/510; 362/509; 362/546

(57) ABSTRACT

A tail light for mounting on a motor vehicle having a rear end and a rear bumper extending generally transversely across the rear end. The tail light is mounted to the rear end above the bumper and has a translucent body comprising an upper portion substantially conforming to a shape of the vehicle body adjacent the light unit, a rear portion angled downward relative to the upper portion, and an air separation edge extending along at least a portion of an intersection between the upper portion and the rear portion along at least the transverse direction of the vehicle. The air separation edge delays air flow separation from the rear of the vehicle body, thereby improving aerodynamic efficiency. The body is made of an elastic material to resist impact damage, and therefore may be mounted closer to a rearmost surface of the bumper without being damaged in a collision.

### CROSS-REFERENCE TO RELATED APPLICATIONS

This application claims foreign priority benefits under 35 U.S.C. §119(a)-(d) to EP 11162253.6, filed Apr. 13, 2011, the disclosure of which is incorporated in its entirety by reference herein.

### TECHNICAL FIELD

This invention relates to vehicle lights and more particularly to vehicle light assemblies which are capable of elastic deformation upon impact with an object.

### BACKGROUND

As vehicles become increasingly aerodynamically designed, there is a desire to provide indicator and tail light assemblies which are integrated into the bodywork and bumpers of the vehicle to provide sleek, smooth, aerodynamic styling. When, however, the light assembly is substantially flush with either of the vehicle's bumpers, an impact with a foreign object or by another bumper could damage the lamp assembly.

Some current light assemblies employ a functional bulb reflector surrounded by what is referred to as a “bright” frame or housing, which is a rigid, high-temperature resistant material (such as nylon or polycarbonate vacuum metallised with aluminium) to create a lamp assembly with an overall shiny or bright appearance. The housing is provided with a transparent protective cover, having one or more colors depending on the function of the light.

A bumper is a protective structure made of steel, aluminium, rubber, or plastic mounted on the front and/or rear of a motor vehicle. When a low-speed collision occurs, the bumper system absorbs the shock to prevent or reduce damage to the car. Some bumpers use energy absorbers or brackets and others are made with a foam cushioning material.

The bumper is mainly designed to prevent or reduce physical damage to the front and rear ends of passenger motor vehicles in low-speed collisions, and typically is not intended to be a structural component that significantly contributes to vehicle crashworthiness or occupant protection during front or rear collisions. Bumpers may be designed to protect the hood, trunk, grille, fuel, exhaust and cooling system as well as safety-related equipment such as parking lights, headlamps and taillights in low-speed collisions.

In order to ensure that vehicle bumpers meet a predetermined standard, many countries have introduced legislation or guidelines. For instance, in the United States the National Highway Traffic Safety Administration (NHTSA) has introduced Federal regulations 49 CFR Part 581. The United Nations Economic Commission for Europe (ECE) regulation No. 42 applies for most vehicles sold in Europe. Canada has its own bumper standard.

A challenge for car manufacturers is therefore that it may be necessary to provide the same models with different bumpers for different markets in order to meet the varying requirements in those markets/countries.

The standard requires that there be no damage to safety-related parts and exterior surfaces not involving the bumper system (e.g., sheet metal; lamps; and fuel, exhaust and cooling systems)

A further challenge relates to aerodynamic design and streamlining of the vehicle body, whereby it is desired to reduce aerodynamic drag. By reducing drag, including drag caused by tail lights, it is possible to reduce fuel/energy consumption and minimise soiling of the rear portion of the vehicle. However, an advantageous aerodynamic design often conflicts with regulations prescribing performance requirements for passenger cars in low-speed front and rear collisions.

In prior art vehicles, the rearmost portion of the bumper would as a rule be arranged with a significant offset away from a rearmost surface of the tail light. This offset would have been selected sufficiently large to prevent any part of the tail light from being struck by the pendulum, in order to prevent damage to the light unit.

### SUMMARY

The tail light disclosed herein is intended to prevent impact damage to certain safety-related equipment, in particular rear lamps and indicators, without requiring a redesign of the bumper in order to meet regulatory test requirements.

According to an embodiment disclosed herein, a tail light unit for a motor vehicle comprises a translucent body having a light emitting area for directing light from an internally-located light source. The translucent body has an upper portion and a rear portion angled downward relative to the upper portion. An air separation edge extends along at least a portion of an intersection between the upper portion and the rear portion along at least the transverse direction when the translucent body is attached to the vehicle. The air separation edge contributes aerodynamic efficiency and reduces drag of the vehicle by delaying flow separation from the rear surfaces of the vehicle.

According to another embodiment, a tail light unit has a translucent body comprising an elastic material. The elastic material is selected to allow the light unit to resist damage that may otherwise be caused by an impact on the rear portion of the vehicle. This allows the rear surface of the tail light unit to be located closer to the rear surface of the bumper, with less “offset” required to protect the tail light.

According to another embodiment, a motor vehicle comprises a rear end, a rear bumper extending generally transversely across the rear end, and a tail light mounted to the rear end above the bumper. The tail light has a translucent body comprising an upper portion substantially conforming to a shape of the vehicle body adjacent the light unit, a rear portion angled downward relative to the upper portion, and an air separation edge extending along at least a portion of an intersection between the upper portion and the rear portion along at least the transverse direction of the vehicle.

### BRIEF DESCRIPTION OF THE DRAWINGS

It is understood that the drawing figures are only illustrations and are not intended to define the scope of the invention, which is defined by the claims appended below. It is further understood that the drawing figures are not necessarily drawn to scale, and that, unless otherwise indicated, the drawing figures only show schematic illustrations of constructions and methods described herein.

FIG. 1 is a schematic side view of a low speed impact test setup;

FIG. 2 is a perspective rear view of a vehicle provided with a light unit;

FIG. 3 is a rear side view of a right rear corner of the vehicle of FIG. 2;

FIG. 4 is a perspective rear view of a left rear corner of the vehicle of FIG. 2;

FIG. 5 is a schematic exploded view of a tail light unit; and

FIG. 6 is a schematic cross-section taken along line 6-6 indicated in FIG. 5.

### DETAILED DESCRIPTION

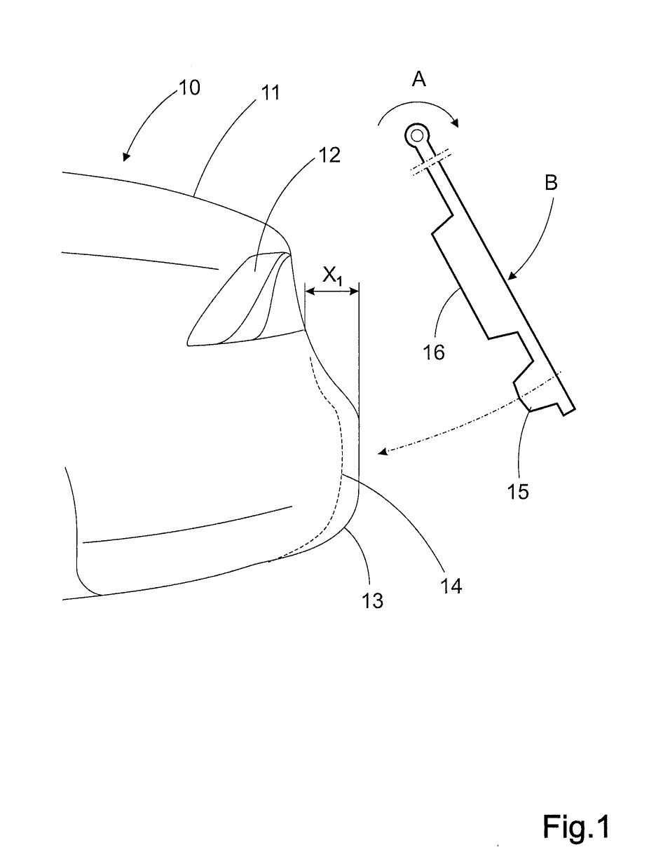

FIG. 1 shows a schematic side view of a low-speed impact test setup, similar to that used for a standard test according to the United States the National Highway Traffic Safety Administration (NHTSA) Federal regulations 49 CFR Part 581. This standard prescribes performance requirements for passenger cars in low-speed front and rear collisions.

FIG. 1 shows a vehicle 10 wherein the rear end 11 thereof is provided with a tail light 12. The lower part of the rear end of the vehicle 10 is provided with a bumper 13. During a test, a pendulum B with first and second impact surfaces 15, 16 swings about an axis A to impact the bumper 13. The first impact surface 15 will strike the bumper 13 causing the bumper to deform, as indicated by a schematic dashed line 14. In order to prevent damage to certain safety related equipment, in particular rear lamps and indicators, the rearmost portion of the bumper 13 is arranged with an offset x₁ away from a rearmost surface of the tail light 12. This offset x₁ must be sufficient to prevent any part of the tail light 12 from being struck by the pendulum B, in particular by the second impact surface 16.

In a prior art vehicle 10 as indicated in FIG. 1, the offset x₁ is often substantial and this solution often places design restrictions on the relative positioning and shape of the bumper in general and the tail light in particular.

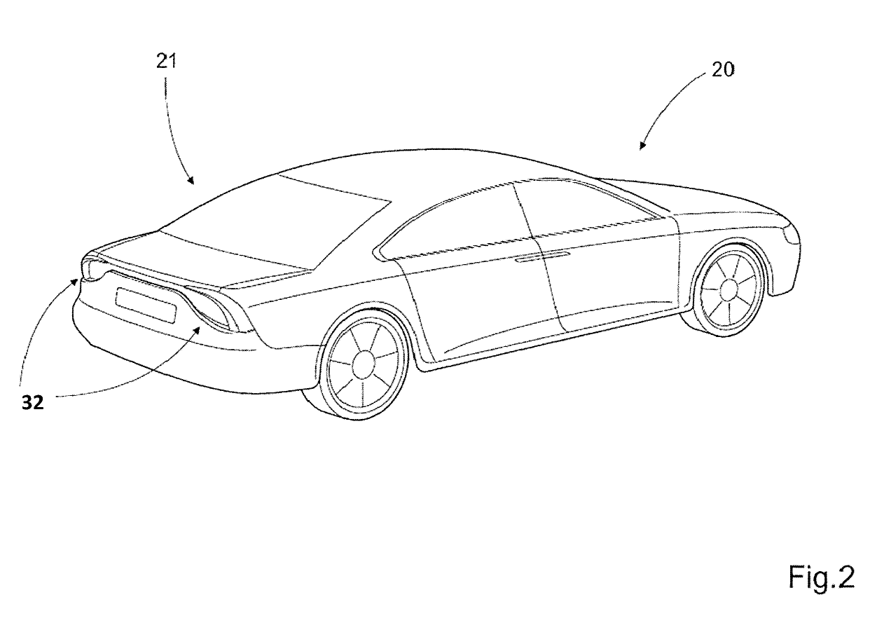

FIG. 2 shows a perspective rear view of a vehicle 20, the rear end 21 of which is provided with a tail light unit 32. The tail light unit 32 is adapted for attachment to the vehicle 20.

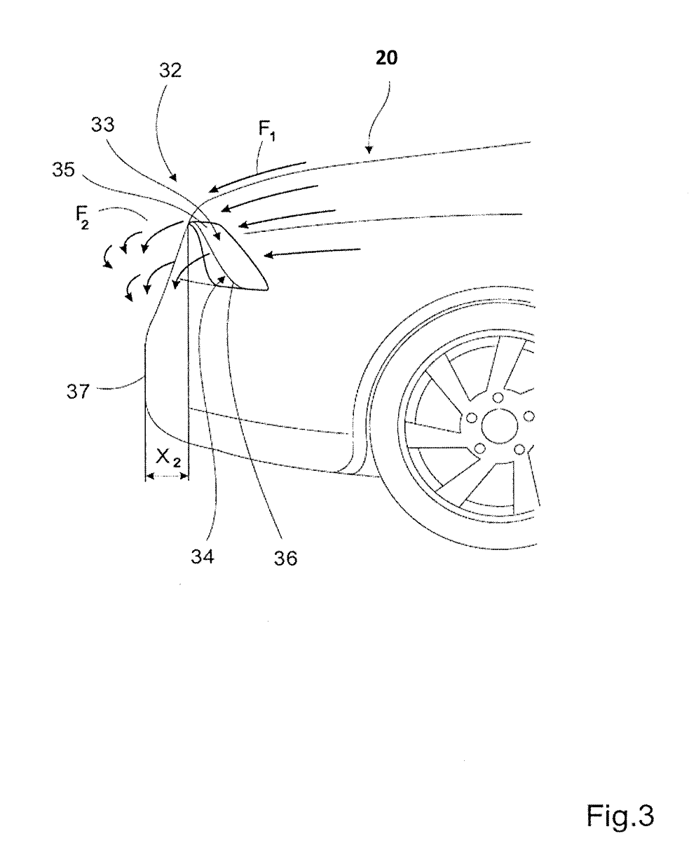

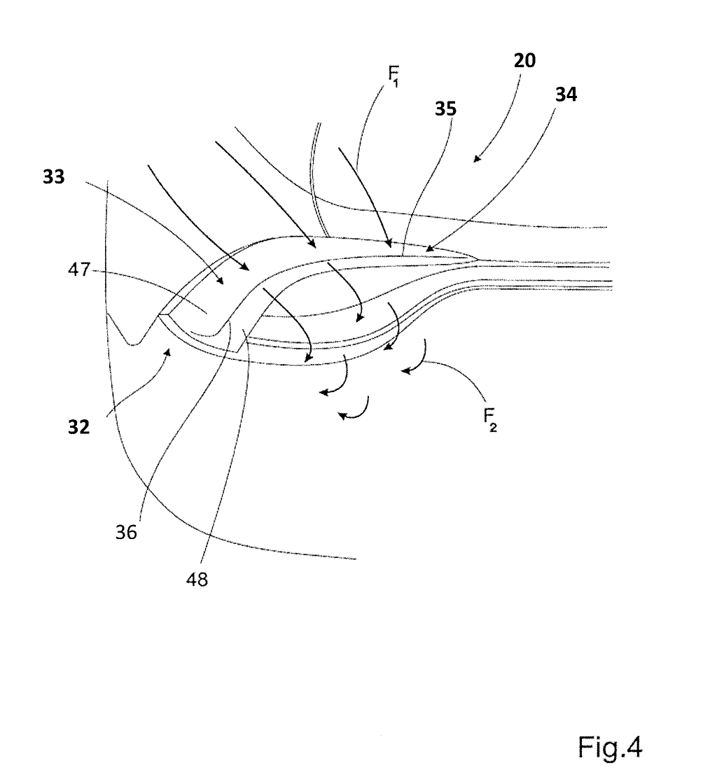

FIGS. 3 and 4 show the right and left corners, respectively, of a vehicle 20 provided with tail light units 32 as shown in FIG. 2. Similar components of the left and right side tail light units 32 are identified with the same reference numbers. The tail light unit 32 comprises a translucent body 33 having an outer surface defining a light emitting area. The translucent body 33 may be formed of a shock absorbing elastic material. This allows the offset x₂ between the rearmost portion of rear bumper 13 and a rearmost surface of the tail light unit 32 to be reduced, as the elastic material is resistant to damage caused by a pendulum in a rear impact test (see FIG. 1).

In this context, the term “light emitting area” is defined as a visible outer surface located in the vehicle body, which surface can be seen by other motorists.

In order to provide the desired shock absorbing properties, the translucent body may be formed of an elastic material with a Shore A hardness of 50-90. The translucent body can be made of a suitable elastic material such as a latex rubber compound or a styrene-butadiene-rubber. Such materials have a light transmittance of 50% or more. Any suitable material with the desired elastic and translucent properties can be used.

The translucent body 33 has an air separation edge 34 extending along at least a portion thereof in at least the transverse direction of the vehicle. As indicated in this example, the air separation edge 34 comprises a first portion 35 extending along the tail light unit 32 in a generally transverse direction relative to the vehicle 20 and a second portion 36 extending at least partially around an adjacent corner of the body of the vehicle 20.

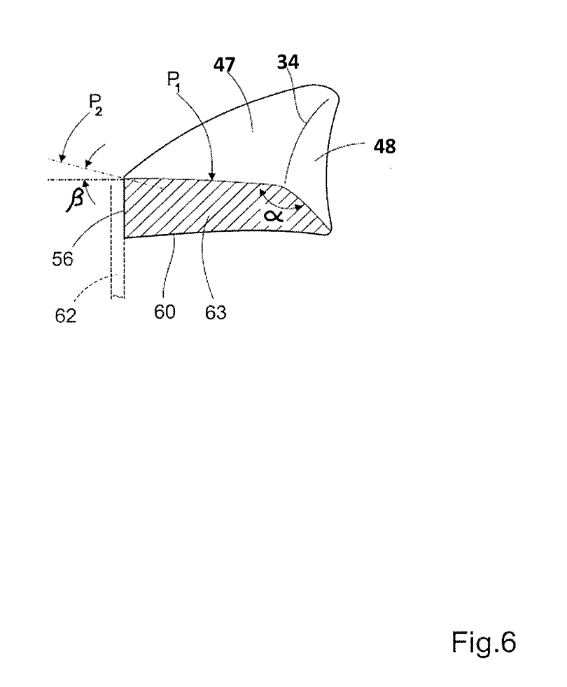

The air separation edge 34 is formed by an edge transition region of the tail light unit, following an upper and a side circumferential contour of the tail light unit 32. The air separation edge 34 is located between an upper portion 47 of the tail light unit substantially conforming to the shape of the vehicle body adjacent the light unit 32, and a downward-angled rear portion 48 of the tail light unit. The angle α (see FIG. 6) between the upper portion of the tail light unit and the rear portion of the tail light unit may advantageously be selected between 90° and 160°. This angle α may be constant or may vary along the entire extension of the air separation edge 34.

As best seen in FIG. 4, the light emitting area can be divided into a substantially upper portion 47 substantially conforming to the shape of the vehicle body adjacent the light unit, and a downward-angled rear portion 48. As stated above, the angle between the upper portion and the rear portion may advantageously be selected between 90° and 160° (see FIG. 6; “a”).

The air separation edge 34 is integrated into the tail light unit 32 and assists air flow separation at the rear end of the vehicle body. A substantially laminar air flow F₁ over the vehicle body is broken up into small vortices F₂ so that the air flow leaves the rear of the vehicle body with reduced turbulence and drag. This arrangement decreases the drag coefficient of the vehicle, increases fuel economy, and helps keep the rear of the vehicle free from dirt.

The motor vehicle rear end has an air separation edge extending along at least a portion of the tail light unit in at least the transverse direction of the vehicle. Alternatively, the air separation edge extends along the tail light unit in the transverse direction and at least partially around the adjacent corner of the vehicle body. These examples are best suited for sedan, coupe or convertible/cabriolet type vehicles, where the tail light units are located adjacent the upper rear edge and/or corner of the luggage compartment. The air separation edge is formed by an edge transition region of the tail light unit, following the upper circumferential contour of the tail light unit. The air separation edge is located between an upper portion of the tail light unit that substantially conforms to the shape of the vehicle body adjacent the light unit, and a downward-angled rear portion of the tail light unit.

In the case of station wagons, hatchbacks or sport utility vehicles (SUV) the tail light units are often located adjacent the rear corner of the luggage compartment. For such vehicles the air separation edge extends around the adjacent corner of the vehicle and at least partially along the tail light unit in the transverse direction and body. In this example, a plane parallel to a side surface of the light unit in a point located adjacent the air separation edge is arranged at an angle β between 3° and 10° relative to a plane parallel to the side surface of the vehicle body located upstream of the point adjacent the location where the vehicle body transitions into the tail light unit. If the side surface of the light unit has a curvature, the main plane of the surface can be used. The longitudinal extension of the side surface of the light unit, i.e. the distance from the point of transition between the body and the light unit up to the air separation edge, is selected sufficient to achieve air separation between the side and rear surfaces of the light unit.

In this example, the term “upstream” is defined relative to the direction in which air is flowing over each point of the vehicle body when the vehicle is travelling in its forward longitudinal direction. An air separation edge is an automotive aerodynamic device, the function of which is to disrupt existing airflow patterns and to ‘spoil’ unfavourable air movement across a body of a vehicle in motion. Many vehicles have a fairly steep downward angle going from the rear edge of the roof down to the rear of the car. At high speeds, air flowing across the roof tumbles over this edge, causing air flow separation. The flow of air becomes turbulent and a low-pressure zone is created, increasing drag and instability. Adding a rear spoiler or an air separation edge makes the air follow a longer, gentler slope from the roof to the spoiler or air separation edge, which helps to delay flow separation. This decreases the drag coefficient, increases fuel economy, and helps keep the rear of the vehicle free from dirt.

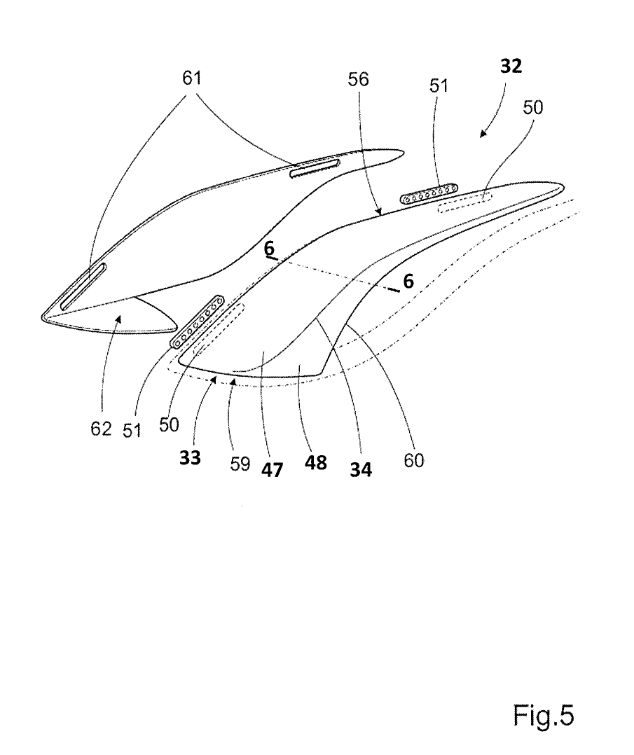

FIG. 5 shows a schematic exploded view of a tail light unit 32. Tail light unit 32 comprises a translucent body 33 defining a light emitting area having an outer surface 47, 48, an inner surface 56 facing the vehicle, and side surfaces 59, 60 between the outer and inner surfaces. The unit according to this embodiment further comprises two mounting sections 50 in the form of recesses in the translucent body 33 for first and second light sources 51 arranged to transmit light into the translucent body.

A support or housing 62 mates with the translucent body 33 to cover a side surface 59 and a rear surface 56 of the translucent body when the unit is assembled. The housing 62 may be provided with recesses 61 for allowing access to the light sources 51. The light sources 51 are shown as holders comprising LEDs, the two holders shown as being substantially identical. However, the size of the holders and/or number of LEDs can be varied dependent on the design of the translucent body.

The translucent body 33 forms a wave guide arranged to direct and disperse light from the light sources 51 into and through the translucent body so as to provide illumination through the light emitting area. The light unit may have an illumination mode in which a first light source provides illumination of a first intensity in a first wavelength range through the light emitting area, and a brake mode in which the first light source provides illumination of a second intensity in the first wavelength range through the light emitting area. These modes can be provided by making each light source vary in intensity, either by varying the intensity of each light emitting unit in the light source or by actuating different numbers of light emitting units in the light source. Alternatively, multiple light sources in different locations on the translucent body can be used. The multiple light sources can be varied in intensity as described above, or by switching on different numbers of light sources in each mode.

FIG. 6 shows a schematic cross-section taken along line 6-6 indicated in FIG. 5. The translucent body 33 is schematically shown with its rear surface 56 attached to the housing 62 (indicated in dashed lines).

A plane P1 is substantially parallel to the upper surface 47 of the light unit at a point located adjacent the air separation edge 34. A plane P2 is substantially parallel to the upper surface of the vehicle body (indicated by a dash-dotted line) located upstream of this point, adjacent the location where the vehicle body transitions into the tail light unit. Plane P1 may be angled between 3° and 10° relative to plane P2. This angle is denoted 13 in FIG. 6. If the upper surface of the light unit has a curvature, the main plane of the surface can be used. The longitudinal extension of the upper surface of the light unit, i.e. the distance from the point of transition between the body and the light unit up to the air separation edge, is selected sufficient to achieve air separation between the upper and rear surfaces of the light unit. This distance is dependent on the relative shape of the vehicle body adjacent the light unit. The distance and angle can be determined by performing a computer based simulation, or by empirical testing in a wind tunnel.

The use of an elastic shock absorbing translucent body for the above purpose allows the use of a light unit as an aerodynamic, drag reducing component while at the same time fulfilling the requirements for impact testing. A tail light unit as disclosed can be placed above a rear bumper on the vehicle and can also extend around the rear corner thereof, while at the same time allowing for a significantly reduced offset relative to a vertical plane through a rearmost portion of the bumper. This will in turn reduce the design constraints on the location of such a light unit.

The assembly may comprise a second light source attached to a side surface or a rear surface of the translucent body, in a location remote from the first light source. The second light source can be configured to provide illumination through at least a predetermined portion of the light emitting area, different from the area illuminated by the first light source, or for varying the intensity of the emitted light as indicated above.

The light source can be located on the vehicle at a location outside the light unit. For example, light can be transmitted through an optical fibre from one or more diode lasers. The optical fibre may be attached to the mounting section to provide a light source arranged to transmit light into the translucent body.

Alternatively, the at least one light source can comprise one or more light emitting diodes (LEDs). In this case the at least one light source comprises single or multiple LEDs mounted in or adjacent a side surface or the rear surface of the translucent body. When multiple light emitting diodes are used, these are preferably mounted together in a unit comprising one line or parallel lines of diodes.

In order to transmit and disperse light within the translucent body, the body has a predetermined light transmittance. The transmittance is the fraction of incident light at a specified wavelength that passes through a sample of a predetermined thickness. The translucent property of a particular material used in the translucent body may give it a “frosted” appearance and determines the maximum thickness and/or the number of light sources required to achieve a desired emission of light through the outer surface of the body. The amount of light transmitted into the translucent body should be sufficient to make the body appear to glow or light up from the inside. This effect can be enhanced by the presence of a trace amount of a suitable activator species to make the material luminescent. The emission of light through the outer surface of the body is adapted to fulfil any legal requirement relating to light emission in the normal mode and brake mode.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tail light unit for a motor vehicle comprising:
a light source; and
a translucent body having a light emitting area for directing light from the light source, the translucent body having an upper portion, a rear portion angled downward relative to the upper portion, and an air separation edge extending along at least a portion of an intersection between the upper portion and the rear portion along at least the transverse direction when the translucent body is attached to the vehicle.

2. The light unit according to claim 1, wherein the light unit has an illumination mode in which the light source provides illumination of a first intensity in a first wavelength range through the light emitting area, and a brake mode in which the light source provides illumination of a second intensity in the first wavelength range through the light emitting area.

3. The light unit according to claim 2, further comprising a second light source remote from the light source and providing illumination through a portion of the light emitting area.

4. The light unit according to claim 2, wherein the light source comprises at least one light emitting diode.

5. The light unit according to claim 1, wherein the translucent body comprises an elastic material.

6. The light unit according to claim 5, wherein the elastic material comprises a latex rubber compound.

7. The light unit according to claim 5, wherein the elastic material comprises a styrene-butadiene-rubber.

8. The light unit according to claim 1, wherein the air separation edge follows an upper circumferential contour of the translucent body.

9. The light unit according to claim 1, wherein the upper portion of the translucent body at a point located adjacent the air separation edge defines a first plane, an upper surface of the vehicle body immediately upstream of the translucent body defines a second plane, and the first plane and the second plane are angled between 3° and 10° relative to one another.

10. A motor vehicle comprising:
a body having a rear end;
a rear bumper extending transversely across the rear end;
a tail light mounted to the rear end above the bumper and having a translucent body comprising an upper portion substantially conforming to a shape of the vehicle body adjacent the tail light, a rear portion angled downward relative to the upper portion, and an air separation edge extending along at least a portion of an intersection between the upper portion and the rear portion along at least the transverse direction of the vehicle.

11. The motor vehicle according to claim 10, wherein the tail light further comprises a light source disposed inside the translucent body and having an illumination mode in which the light source provides illumination of a first intensity in a first wavelength range through the light emitting area, and a brake mode in which the light source provides illumination of a second intensity in the first wavelength range through the light emitting area.

12. The motor vehicle according to claim 11, wherein the light unit further comprises a second light source remote from the light source and providing illumination through a portion of the light emitting area.

13. The motor vehicle according to claim 11, wherein the light source comprises at least one light emitting diode.

14. The motor vehicle according to claim 10, wherein the translucent body comprises an elastic material.

15. The motor vehicle according to claim 14, wherein the elastic material comprises a latex rubber compound.

16. The motor vehicle according to claim 14, wherein the elastic material comprises a styrene-butadiene-rubber.

17. The motor vehicle according to claim 10, wherein the air separation edge follows an upper circumferential contour of the translucent body.

18. The motor vehicle according to claim 10, wherein the upper portion of the translucent body at a point located adjacent the air separation edge defines a first plane, an upper surface of the vehicle body immediately upstream of the translucent body defines a second plane, and the first plane and the second plane are angled between 3° and 10° relative to one another.

19. The motor vehicle according to claim 10, wherein an offset between a first vertical plane through a rearmost portion of the bumper and a second vertical plane through a rearmost surface of the tail light is selected so that the translucent body comprising the elastic material is impacted by a pendulum during a rear impact test.

20. A tail light for a motor vehicle comprising:
a light source; and
a translucent body formed of an elastic material and having a light emitting area for directing light from the light source, the translucent body having an upper portion, a rear portion angled downward relative to the upper portion, and an air separation edge extending along at least a portion of an intersection between the upper portion and the rear portion along at least the transverse direction of the vehicle.
